(19) United States
(12) Patent Application Publication
(10) Pub. No.: US 2015/0156144 A1
(43) Pub. Date: Jun. 4, 2015

(54) Methods and Systems for Social Messaging

(71) Applicants: Rajesh Srivathsa, Bengaluru (IN); Mahesh Rajagopalan, Irving, TX (US); Gurumurty Panku, Bengaluru (IN); Jitendra Jagdev, Bengaluru (IN); Amarendra Sahu, Bengaluru (IN)

(72) Inventors: Rajesh Srivathsa, Bengaluru (IN); Mahesh Rajagopalan, Irving, TX (US); Gurumurty Panku, Bengaluru (IN); Jitendra Jagdev, Bengaluru (IN); Amarendra Sahu, Bengaluru (IN)

(73) Assignee: MYNDBEE, INC., Irving, TX (US)

(21) Appl. No.: 14/550,947

(22) Filed: Nov. 22, 2014

Related U.S. Application Data
(60) Provisional application No. 61/908,622, filed on Nov. 25, 2013.

(51) Int. Cl. H04L 12/58; H04L 29/06

(52) U.S. Cl. CPC H04L 51/04; H04L 63/0421

(57) ABSTRACT

The methods and systems in this invention apply to messaging systems that are used by people to communicate between a plurality of mobile devices and/or computers. Methods and systems are presented for communicating with participants in a manner that allows for more open discussion and gossiping. The methods and systems permit a conversation between a plurality of users in a manner such that one or more users in the system are excluded from participating in the said conversation. The methods and systems also allow one or more users to participate in a conversation without revealing identity by choosing to be anonymous, choosing an alias, or by impersonating another user or reverting to original identity at any point during the gossip. The methods and systems presented also provide for the option for other users to know if a user is participating by impersonating or via an alias. The methods and systems also allow for any user in the system to delete any message posted by the said user in a conversation. Further the originator of the conversation may also delete the entire conversation.

### CROSS REFERENCE TO RELATED APPLICATIONS

This application claims priority to U.S. Provisional Patent Application No. 61/908,622 filed Nov. 25, 2013, which is hereby incorporated by reference in its entirety.

### FIELD OF INVENTION

The present invention applies to social messaging using computer-based systems.

### STATEMENT REGARDING SPONSORED RESEARCH OR DEVELOPMENT

Not Applicable.

### BACKGROUND OF THE INVENTION

Mobile messaging systems allow users on mobile devices such as mobile phones, tablets, and mobile computers to communicate with one another individually and as groups, see (US Patent Application 2006/0072721; US Patent Application 2009/0176518; US Patent Application 2006/0194596; US Patent Application 2009/0061825; U.S. Pat. No. 8,001,184). Many of today's systems emerged as improvements on the Short Message Service (SMS) offered by telecom carriers and Instant Messaging (IM) services offered by early Internet companies. Examples of today's mobile messaging systems include iMessage, WhatsApp, Line, Kakao Talk, Google Talk, Kik, SnapChat, and Path, to name a few. While SMS supports only simple text, todays Messaging systems such as WhatsApp allow for the exchange of text, audio snippets, images, and videos to enhance and facilitate better messaging. Other services, such as Line, enable the use of Custom Emoticons/Stickers to help users personalize their messages and be more expressive. Stickers allow for rich interaction on small-form-factor mobile devices and are especially useful if text is in a language not supported well by standard QWERTY keyboard (e.g. Japanese).

However, today's Messaging platforms lack important features that could enhance usage by permitting users to exchange information with confidence. (1) One such feature is the ability for a user to ensure that specific users cannot be added to a group conversation (“Exclusion”). (2) Another feature missing in today's systems is the ability for a user to choose to be anonymous or use an alias on an as needed basis (“Anonymity/Alias”). Some of those issues were addressed to a degree by others in communication systems other than Instant Messaging, e.g., e-mail or online discussion groups/forums, see (U.S. Pat. No. 6,209,100; U.S. Pat. No. 7,882,184; U.S. Pat. No. 7,818,376; U.S. Pat. No. 6,721,785; US Patent Application 2008/0183822). The present invention comprehensively addresses these gaps for Instant Messaging. In the description of the invention we refer to a conversation as a “gossip” and a user participating in the gossip as a participant.

### BRIEF SUMMARY OF THE INVENTION

The current invention describes methods and systems that address points (1) and (2) described above. First, the current invention makes it possible to exclude a chosen user or users from becoming a participant(s) in a gossip. An Identity Service is used to uniquely identify every user (irrespective of the device or devices used by said user). Further, an Exclusion List is associated with each gossip. The Exclusion List tracks each unique user excluded from the gossip by utilizing the Identity Service. Either the creator of the gossip or optionally any subsequent participant in the gossip may add users to the Exclusion List. While a participant may be added to the Exclusion List to prevent subsequent participation, in the typical manifestation of this invention only a non-participant user is eligible to be excluded. Whenever someone tries to add a new participant to an existing gossip the system queries the Identity Service to establish the identity of the added user and checks the Exclusion List before permitting access to view a gossip or to participate in said gossip. In another manifestation of this invention a participant may add to the Exclusion List a special token “everyone-else”. Once this token is added to the Exclusion List the gossip's participant list is locked and no new users are permitted to become participants and hence no new user may view the gossip or participate in the gossip from any of her devices. Upon exclusion of participant(s) from a gossip, the current invention makes it possible for the system, at its discretion, to inform the excluded people through various communication means available to it including but not limited to sms, email, in-app communication & notification irrespective of whether they are users of the gossip app or not. The current invention makes it possible for any participant who excluded non-participants to revert the exclusion. In such a case, the non-participant can join the gossip.

The current invention makes it possible to create a gossip or participate in a gossip either (a) by using one's own name or identifier, (b) anonymously, (c) by using an alias, e.g., a completely made-up name, a name of a famous person, a fictitious character, etc., or (d) by impersonating another user either by picking from the app contact list or by providing such user's identity in the system. The choice of switching between one's real identity, assumed identity, or anonymity may be changed from time to time within a gossip. An Identity Service is used to uniquely identify every user. However, if the user chooses anonymity or an alternate identity or an alias, the identity displayed to the other participants in the gossip is appropriately changed. Optionally, to other participants the said user's identifier may show up with a marker (such as a question mark following the displayed identifier) to indicate that the identity displayed may not be correct. Gossip participants may however be sure that, since an Identity Service is employed, users on the excluded list would not gain access to the gossip irrespective of their assumed name or anonymity. The current invention makes it possible for collaborative discovery by other users in a gossip of any user who has chosen to be anonymous or is using aliasing or impersonation. A typical manifestation would be when more than a threshold number of participants in a gossip express their desire to know the real identity of one or more participants in the gossip, the system shall make such participant's real identity known to other participants.

### BRIEF DESCRIPTION OF THE DRAWINGS

The accompanying drawings, wherein like referenced numerals are employed to designate like parts or steps, are included to provide further understanding of the invention and are incorporated in and constitute a part of this specification, illustrate embodiments of the invention and, together with the description, serve to explain the principles of the invention.

In the drawings:

FIG. 1 shows one use scenario of an embodiment of the invention where plurality of users use a Gossip App running on mobile devices to communicate Gossips between them. A central server on Internet is involved in the communications.

FIG. 2 shows a similar scenario, but without a central server. All Gossip communication is peer-to-peer between the Apps.

FIG. 3 shows a setup similar to FIG. 1, but with one of the users using a Gossip App running on desktop computer.

FIG. 4 shows a setup similar to FIG. 1, but with one of the users replaced by a computer program sending or receiving Gossips.

FIG. 5 shows the main components of the Gossip App.

FIG. 6 shows the components of the Server which was depicted in FIGS. 1, 3, & 4.

FIG. 7 shows the typical components of a Gossip representation used by the Gossip app that can be sent from the Gossip App.

FIG. 8 shows the typical components of a Participant representation used by the Gossip app.

FIG. 9 shows a Gossip similar to FIG. 7 but with some of the Participants corresponding to a computer program rather than a real person User.

FIG. 10 shows the typical components of a Message representation used by the Gossip app.

FIG. 11 shows actions possible on a Gossip during its lifetime.

FIG. 12 shows steps involved in creating a Gossip.

FIG. 13 shows steps involved in adding a new message to a Gossip.

FIG. 14 shows steps involved in adding a new Participant to a Gossip.

FIG. 15 shows steps involved in excluding a Participant from a Gossip.

FIG. 16 shows steps involved in removing a Message from a Gossip.

FIG. 17 shows steps involved in altering the author name displayed with a Message in a Gossip.

### DETAILED DESCRIPTION OF THE PREFERRED EMBODIMENTS

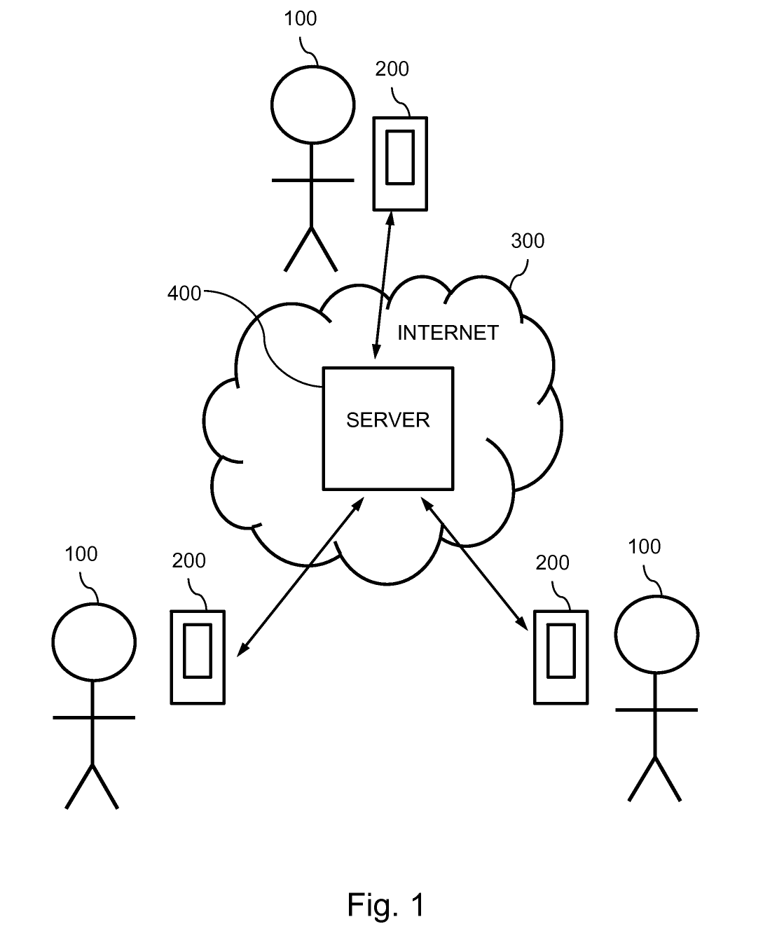

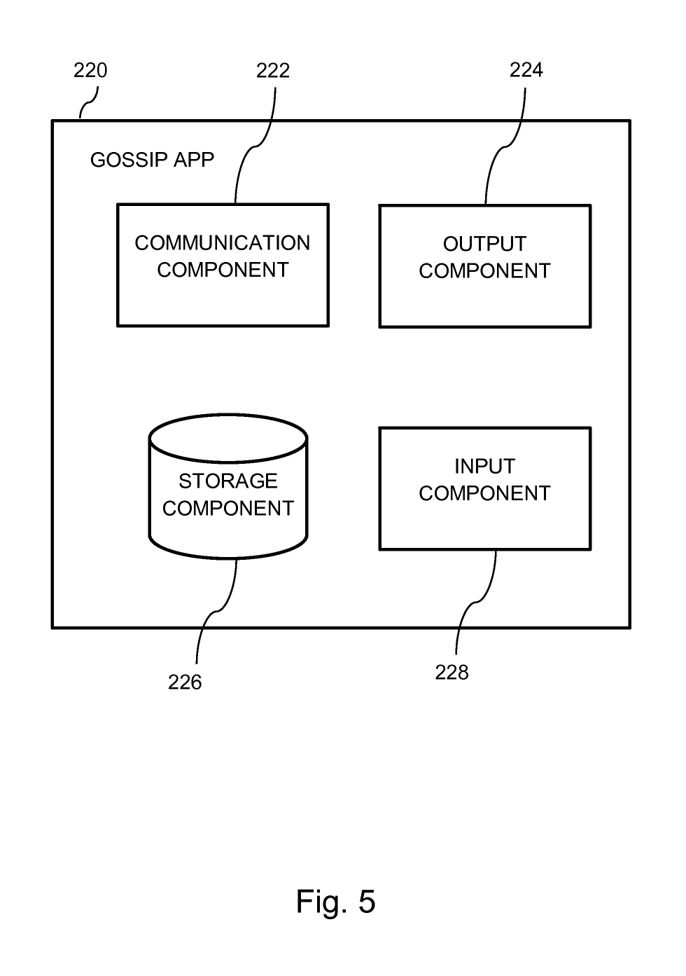

FIG. 1 shows a typical use scenario of an embodiment of the invention. A plurality of Users 100 use their Mobile Devices 200, which can be any mobile device capable of executing a computer program and communicating over a computer network, for example, a smart phone or a tablet. A Gossip App 220, see FIG. 5, is running on each of the Mobile Devices 200. Users 100 can use the Gossip App 220, to exchange gossip messages with other Users 100. Gossip messages are exchanged over Internet 300. Server 400 accessible over Internet 300 is involved in the exchange of the gossip messages.

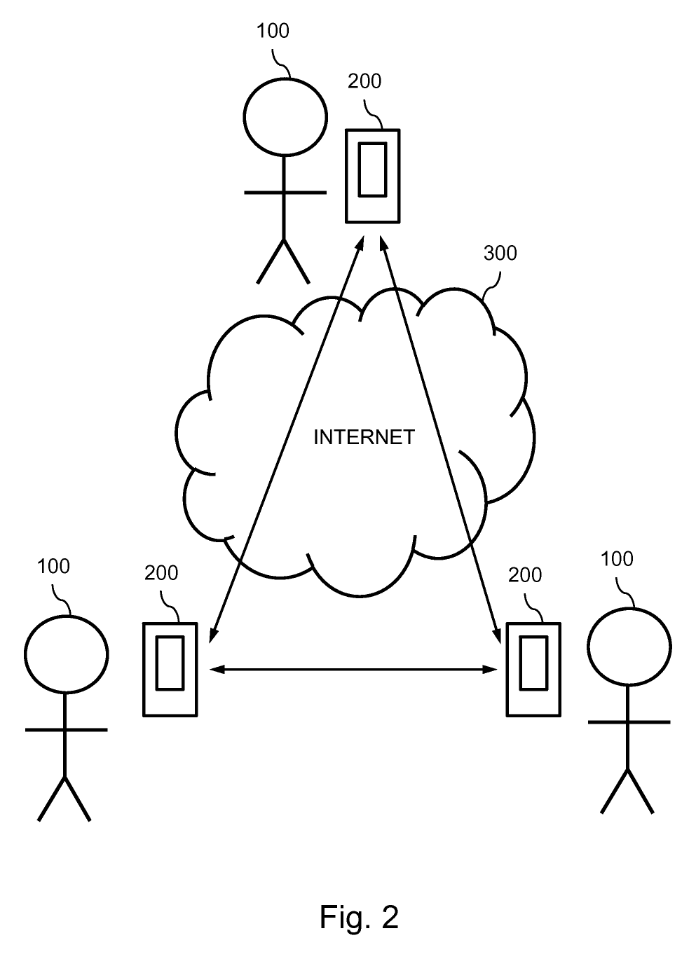

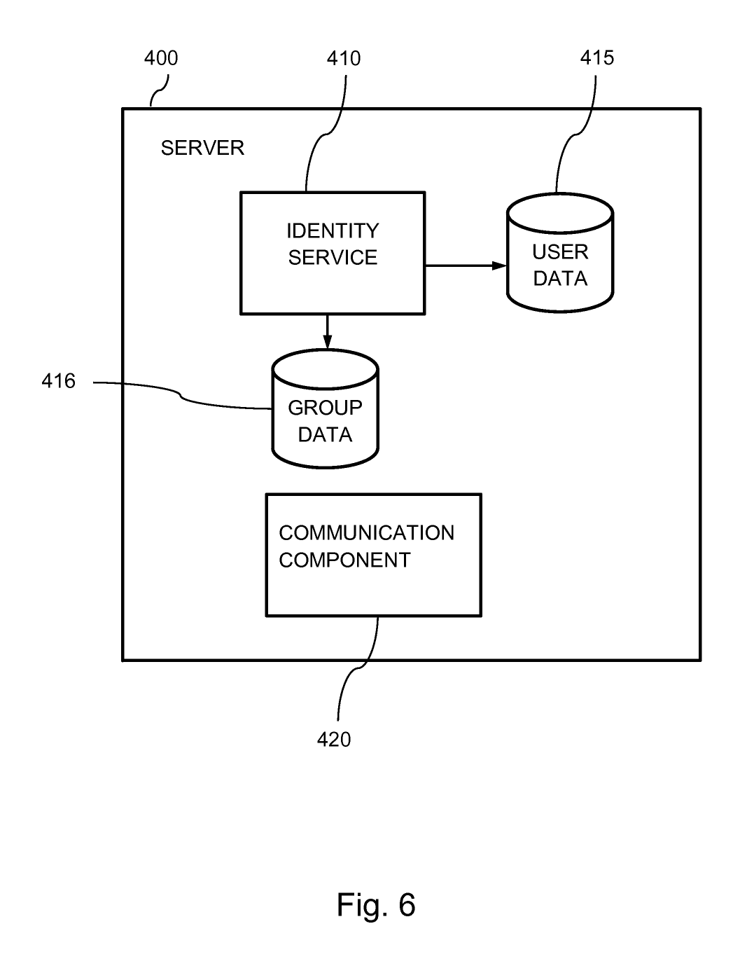

FIG. 2 shows another possible use scenario. In this scenario an alternative manifestation of the invention allows the Gossip App 220 running on Mobile Devices 200 to communicate peer-to-peer without involvement of a central Server 400. Any information that would be stored on Server 400, see FIG. 6., is now stored in a distributed manner over the Gossip App 220 peers.

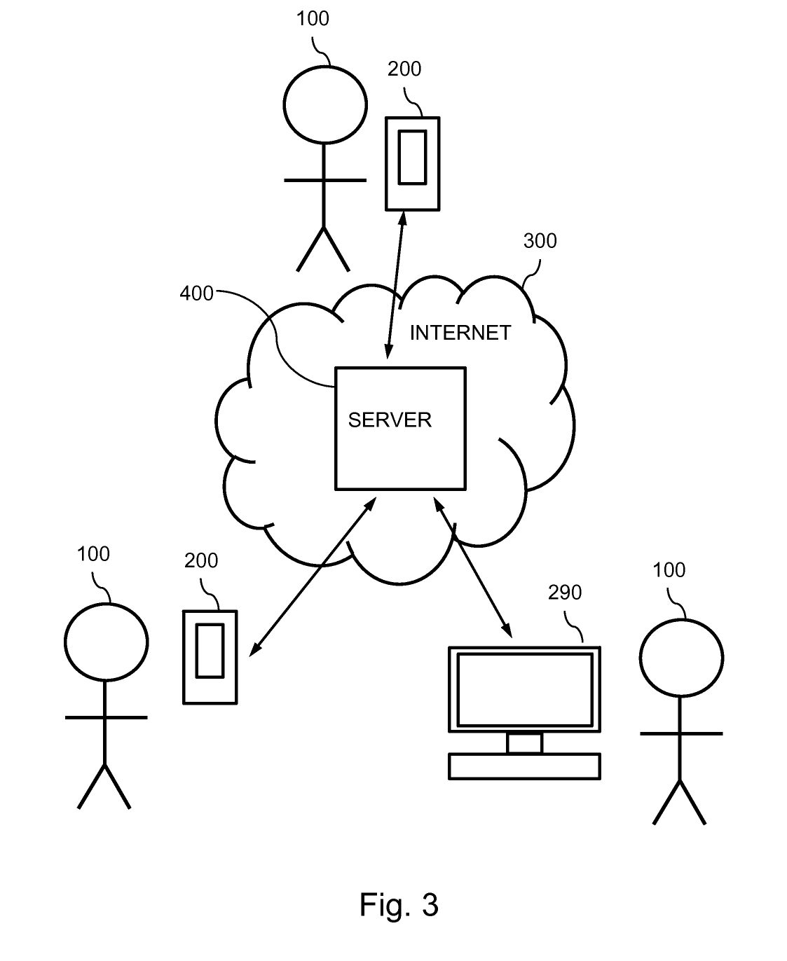

FIG. 3. shows that Gossip App 220 is not limited to use on Mobile Devices 200 only. Gossip App 220 can be also implemented on any computing device with a display which is able to communicate over a computer network. These include physical computing devices like Personal Desktop Computers, laptops, netbooks, etc., and also virtual computing devices, e.g., ECMAScript enabled Web Browsers. This scenario is illustrated in FIG. 3, which is similar to FIG. 1, but with one of the Mobile Devices 200 replaced by a Desktop Computer 290. Similarly a Desktop Computer 290 could replace any or all Mobile Devices in a peer-to-peer scenario shown in FIG. 2.

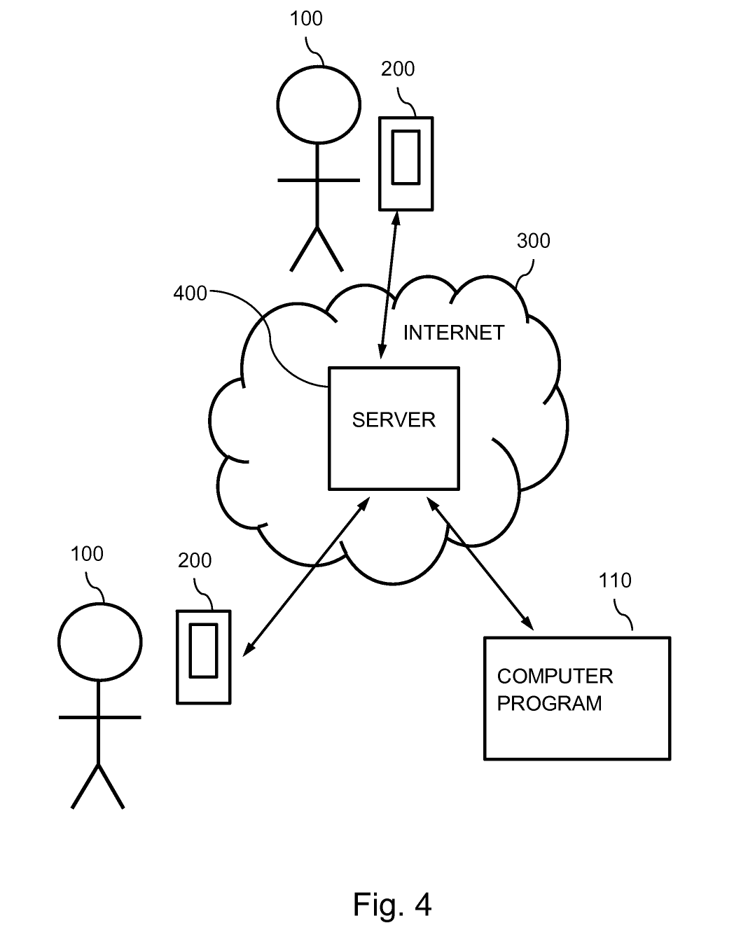

FIG. 4 shows a possible scenario where a user of the app (see 100 in FIG. 1) is replaced by a computer program. The Computer Program 110 can incorporate the functionality of Gossip App, for example, by including its code provided in a form of a software library, which is illustrated in FIG. 4, or it can communicate with a stand-alone Gossip App, or an equivalent Gossip App service, via a an API, using means well-known to a person versed in the art.

An example of a scenario shown in FIG. 4 is a setup where the Computer Program 110 originates some of the Gossips by monitoring some source of news on Internet 300 and automatically sending a Gossip when a specific type of news occurs. An example where the Computer Program 110 consumes the Gossips is a setup where it monitors the Gossips that it receives and posts some of them to a Social Media website, for example, Facebook.

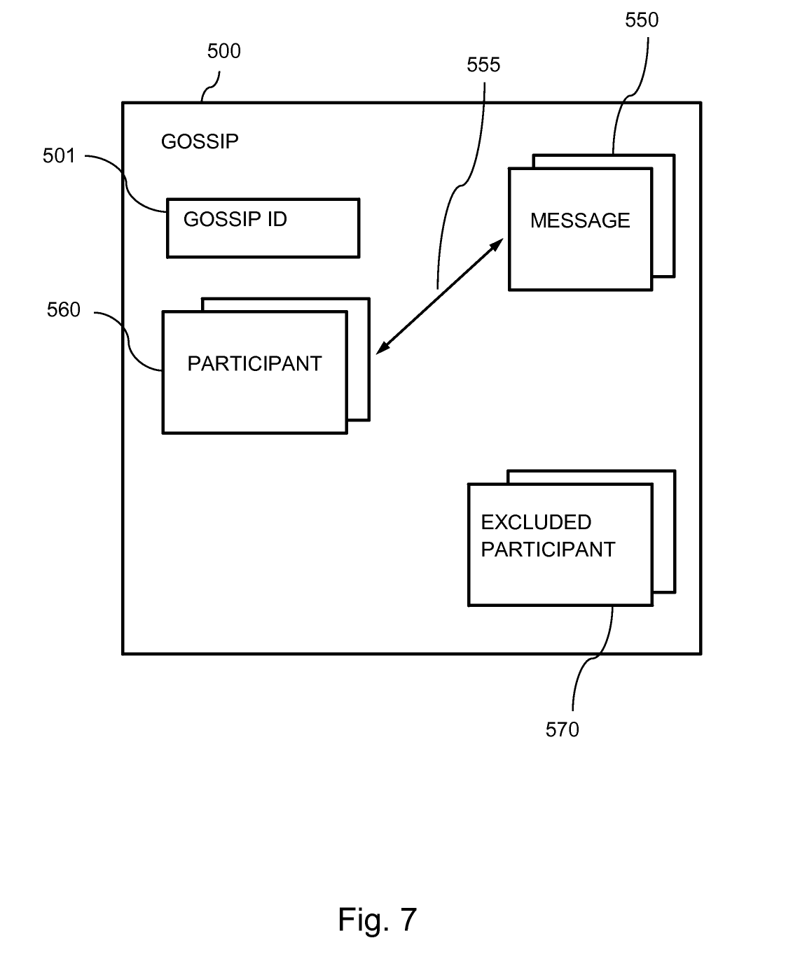

FIG. 5 shows the main components of the Gossip App 220 in the preferred embodiment. Output Component 224 allows a User 100 to access the Gossips (see 500 in FIG. 7). The Output Component 224 may use a screen to communicate the information to the user in the form of text, graphics, images, video, etc., but it can also use other media, for example, audio for recorded voice, music, text-to-speech etc. The Input Component 228 allows the User 100 to provide commands to the Gossip App 220. It allows the User 100 to perform actions like controlling the view, creating new Gossips 500, editing Messages (see 550 in FIG. 7) as well as any other actions provided by the Gossip App 220. The Input Component 228 can be implemented as a keyboard, keypad, touch screen, automatic speech recognition (ASR), optical character recognition (OCR), gesture recognition, video or audio recording, or any other means of providing input to a computing device.

Storage Component 226 stores the Gossip 500 and other data needed to support the functionality of the Gossip App 220. The extent of the data stored in the Storage Component 226 depends on the embodiment of the invention and a specific use scenario. In an embodiment supporting use scenario illustrated in FIG. 1 the data stored in the Storage Component 226 may be limited to transient data as shown on the Output Component 224 or entered via the Input Component 228. In an embodiment supporting peer-to-peer use scenario illustrated in FIG. 2, the Storage Component 226 may store a portion of the distributed state of all live Gossips 500 shared among the Users 100.

In scenarios as shown in FIG. 4, involving a Computer Program 110, a manifestation of the Gossip App 220 may be used where the Output Component 224 and the Input Component 228 are implemented to support interaction with a Computer Program 110. It should be noted here that a single use scenario may include a plurality of embodiments of the Gossip App, for example, one embodiment used by a human User 100, which another embodiment is used by a Computer Program 110.

The Communication Component 222 enables the Gossip App 220 to send the gossips to and receive gossips from other Gossip Apps 220. Depending on the use scenario (e.g. FIG. 1. vs FIG. 2) the Communication Component 222 will communicate either with a Server 400 or with other Gossip Apps 220. In some embodiments a mixture of server mediated and peer-to-peer communication may be used. Communication may be accomplished using either standard protocols like XMPP or using a proprietary protocol. A plurality of protocols may be used to accomplish the communication.

FIG. 6 shows the components of the Server 400. Server 400 contains a Communication Component 420 that is used to communicate with the Communication Component 222 of Gossip Apps 220 as described for FIG. 5. Server 400 also contains an Identity Service 410. The main purpose of the Identity Service 410 is to uniquely identify Users 100 of the Gossip App 220. Ability to identify Users 100 is important to this invention because of the Exclusion and Impersonation features. In the preferred embodiment of the invention the identity is tied to a User 100 via a phone number. In other embodiments User 100 identity could be tied to other unique identifiers, e.g., email address, a user name unique among all Gossip App 220 users, IMEID, etc.

In the preferred embodiment, Identity Service 410 stores user related information as User Data 415. The User Data 415 can include, e.g., the name under which a user wants to be known within the system, the user's avatar, etc. In some embodiments of the invention, User Data may also comprise history of aliases used by the user, gossip participation history, etc. In addition to User Data 415, the preferred embodiment also stores Group Data 416. The Group Data 416 defines groups of Users 100, and all group attributes, like name, visibility, etc. Group Data 416 is used in the preferred embodiment of the invention as a means of identifying multiple Users 100, e.g., when adding new participants to a gossip, or excluding them from a gossip.

Although in the preferred embodiment Identity Service 410 is implemented in the Server 400, in other embodiments the entire or part of the functionality of the Identity Service 410 can be implemented in a distributed manner, without using a central server. Details of a distributed implementation are not the subject of this invention, and any suitable method know to those skilled in the art can be used to implement a distributed Identity Service 410 to be used by an embodiment of this invention.

FIG. 7 shows the components of a Gossip 500 that can be communicated between the Gossip Apps 220 in the preferred embodiment. A Gossip 500 comprises Gossip ID 501, which uniquely identifies the Gossip 500, one or more Message 550 objects and a plurality of Participant 560 objects which define which Users 100 the Gossip 500 is made available to. Though in the preferred embodiment there is a one-to-one relationship between a Participant 560 and a User 100, other embodiments may allow many-to-many relationship, or may map Participants 560 also to user groups as defined in Group Data 416. Gossip 500 may maintain the relationship 555 between the Participants 560 and the Messages 550, for example, (1) for the purpose of determining message ownership, and (2) to identify messages 550 which were created prior to the Participant 560 joining a Gossip 500. A Gossip 500 may also comprise one or more Excluded Participant 570 objects. Excluded Participant 570 objects define the exclusion lists, namely which Users 100 the Gossip 500 should never be distributed to, or which is equivalent, which Users 100 should not be allowed to view the Gossip 500. In the preferred embodiment, Users 100 identified as Excluded Participants 570 may never become Participants 560 of a Gossip 500. The preferred embodiment implements also a special type of Excluded Participant 570 identified as “everyone else”. If such an Excluded Participant 570 is defined in a Gossip 500, it is not possible to add any new participants to the Gossip 500 unless the exclusion is undone. In some embodiments, Gossip 500 may also comprise other data used to reduce communication with the Server 400 and reduce resource requirements of Server 400.

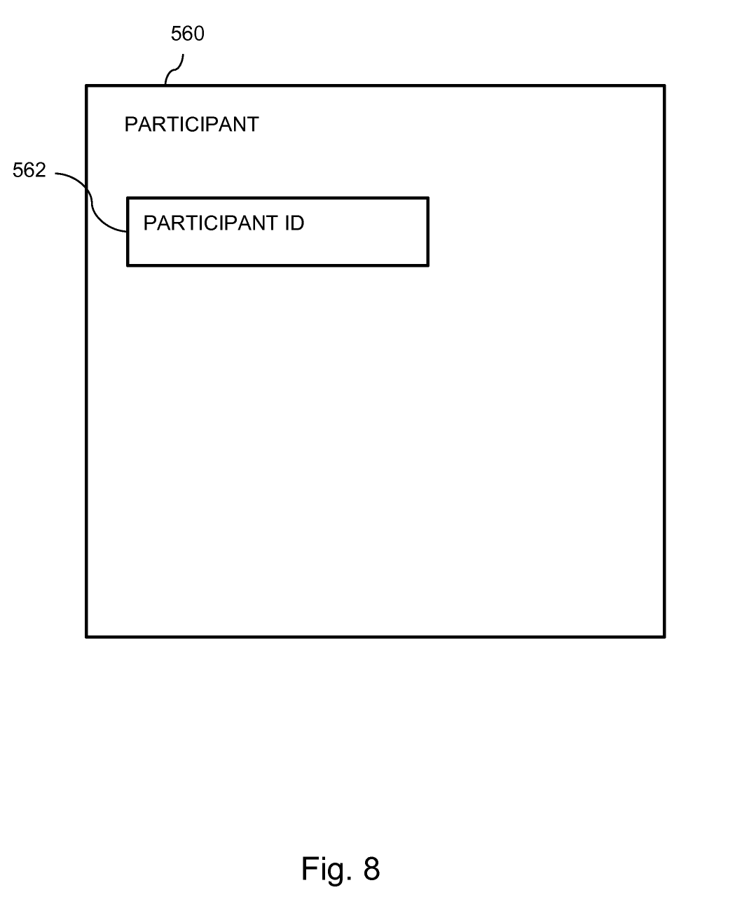

FIG. 8 shows the main components of a Participant 560 object in the preferred embodiment. A Participant 560 has a Participant ID 562 which uniquely identifies the participant as one of the Users 100. Identity Service 410 (see FIG. 6) is used to determine User 100 identity. In other embodiments, Participant 560 object may store also, either complete or as references, user name, user avatars, or other user data.

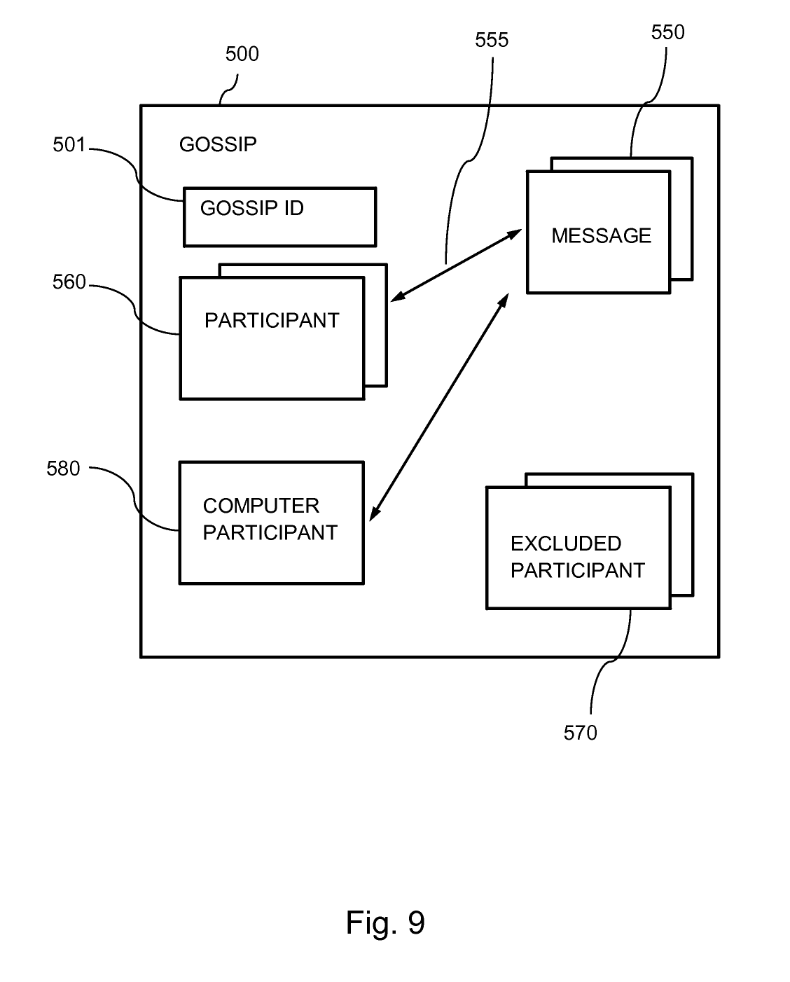

FIG. 9 shows a Gossip 500 similar to FIG. 7 but in this case the Gossip 500 also comprises one or more Computer Participants 580 corresponding to Computer Programs 110 from scenario shown in FIG. 4.

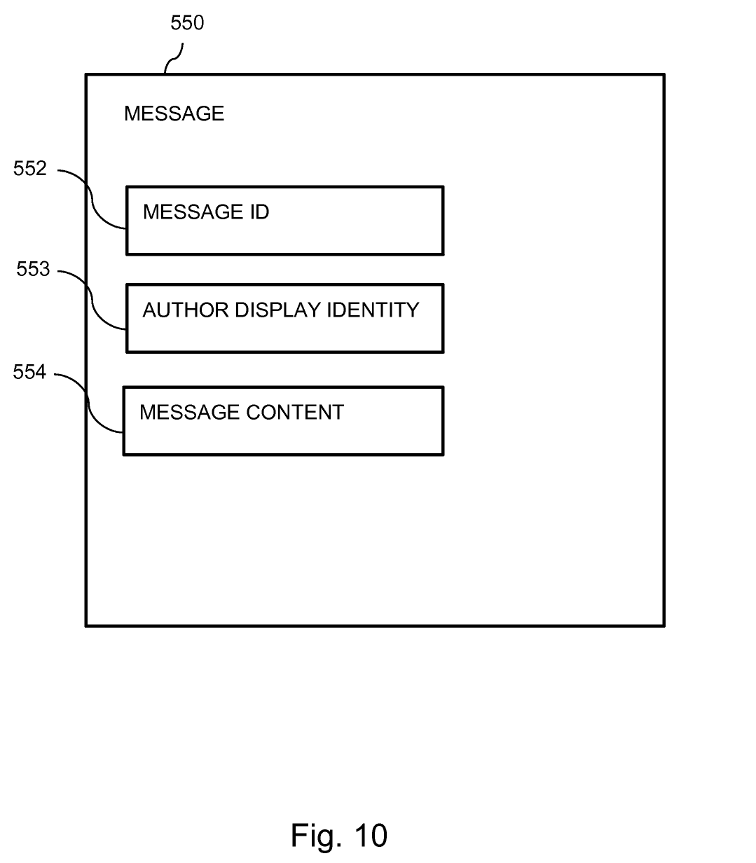

FIG. 10 shows the main components of a Message 550 object in the preferred embodiment. A Message 550 comprises a Message ID 552 which uniquely identifies the Message 550. A Message 550 further comprises Author Display Identity 553, which can be either (a) the participant name (as defined in Identity Service 410), or it can be (b) missing if the Participant 560 wants to send the Message 550 anonymously, or it can be (c) an arbitrary alias if the Participant 560 wants to hide the identity that way, or it can be (d) a name of another User 100 if the Participant 560 wants to impersonate another User 100. In cases b), c), and d) the preferred embodiment can determine the true author identity by means of the relationship 555 between Participant and Message. The Message 550 may display on the Output Component 224 differently depending on which of the four types a), b), c), or d) of Author Display Identity 553 is used in the Message 550. A Message 550 also comprises a Message Content 554. Message Content 554 may be one or more of: text, image, emoticons, audio, video, drawings (doodles), location info, etc.

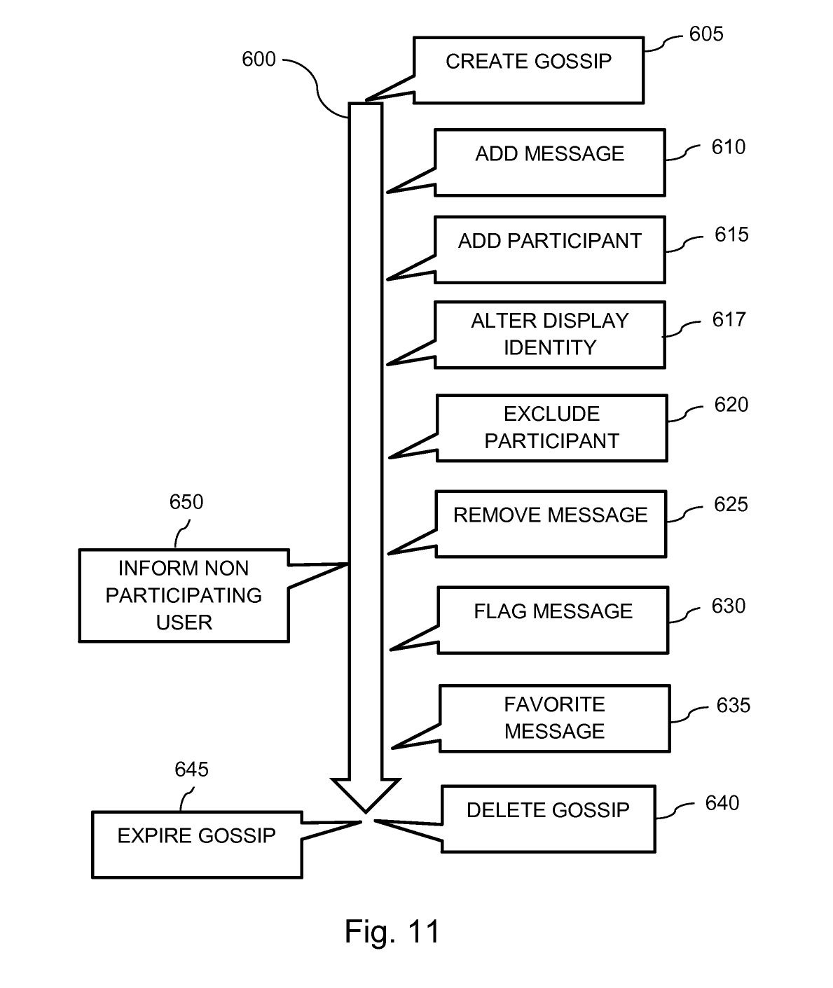

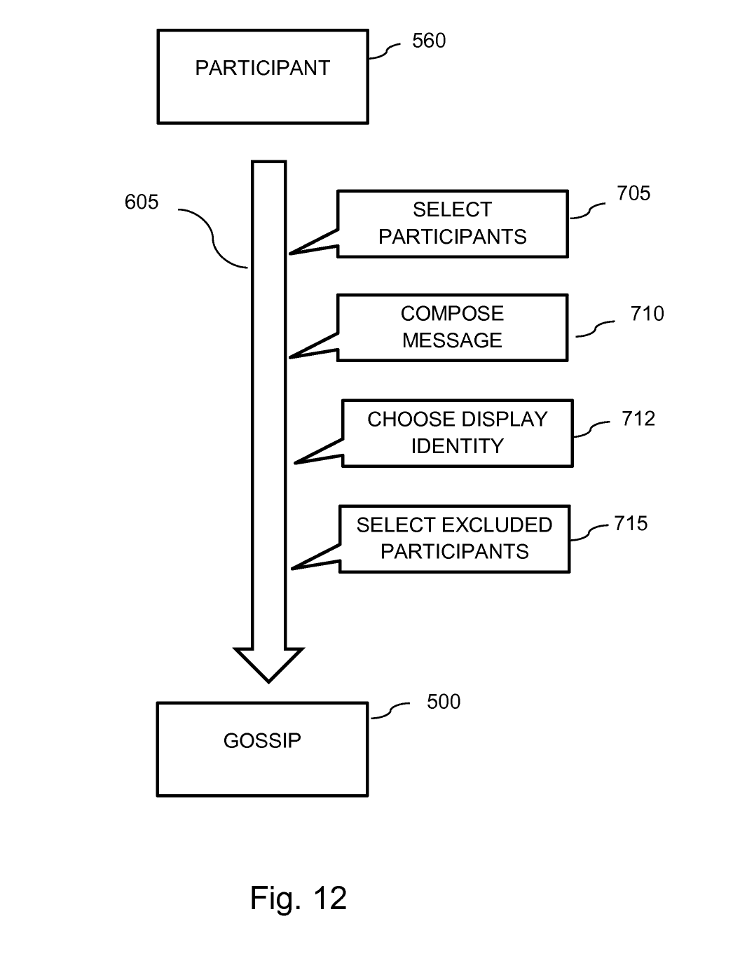

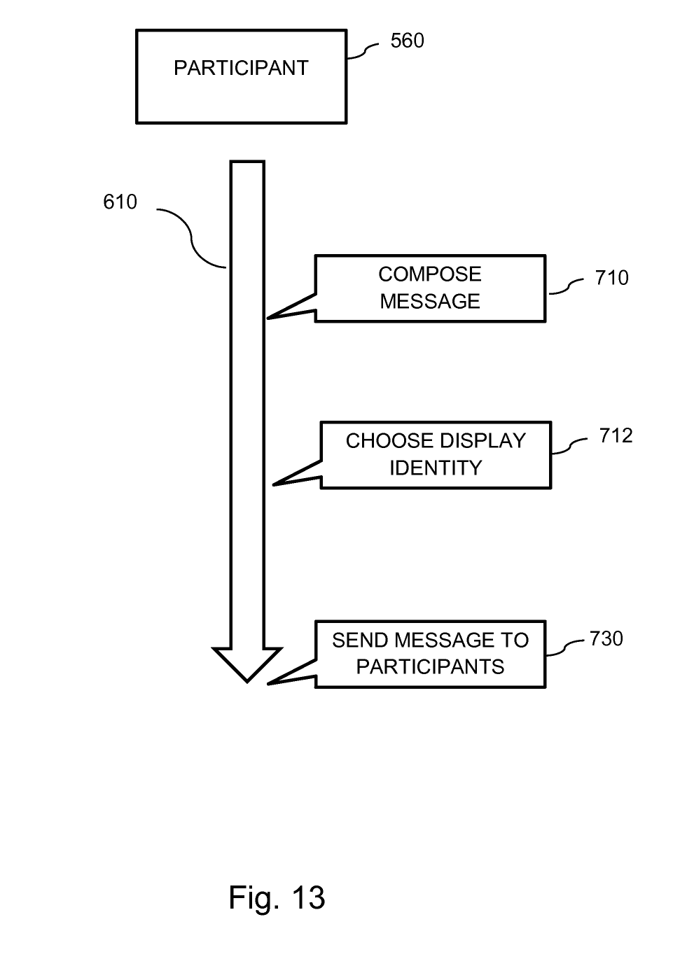

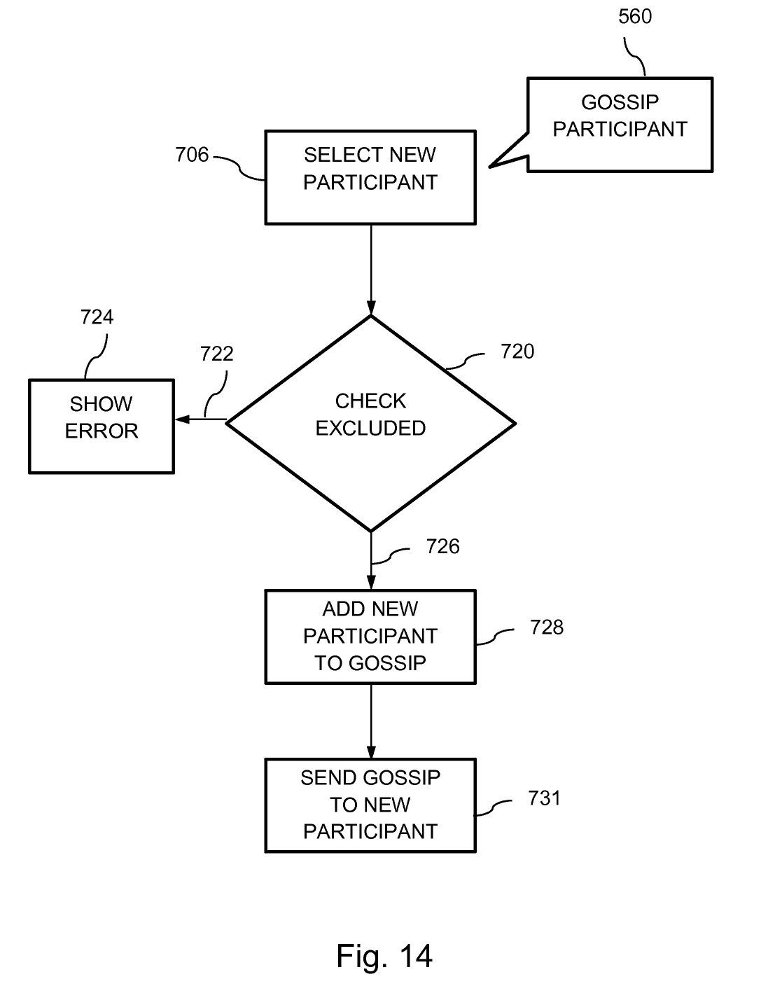

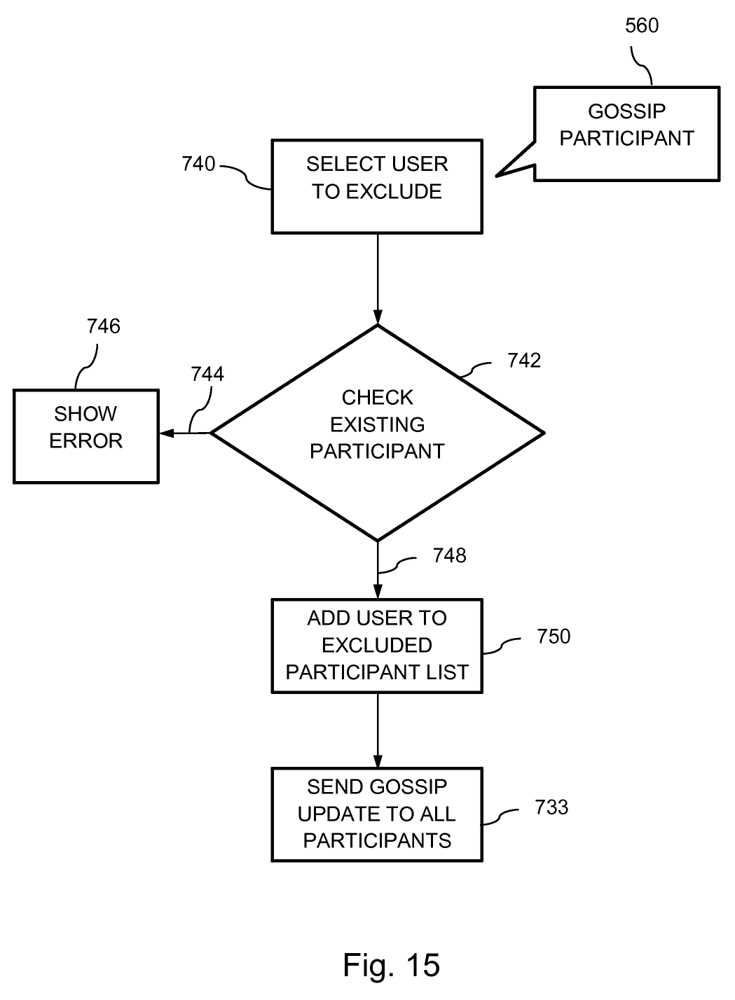

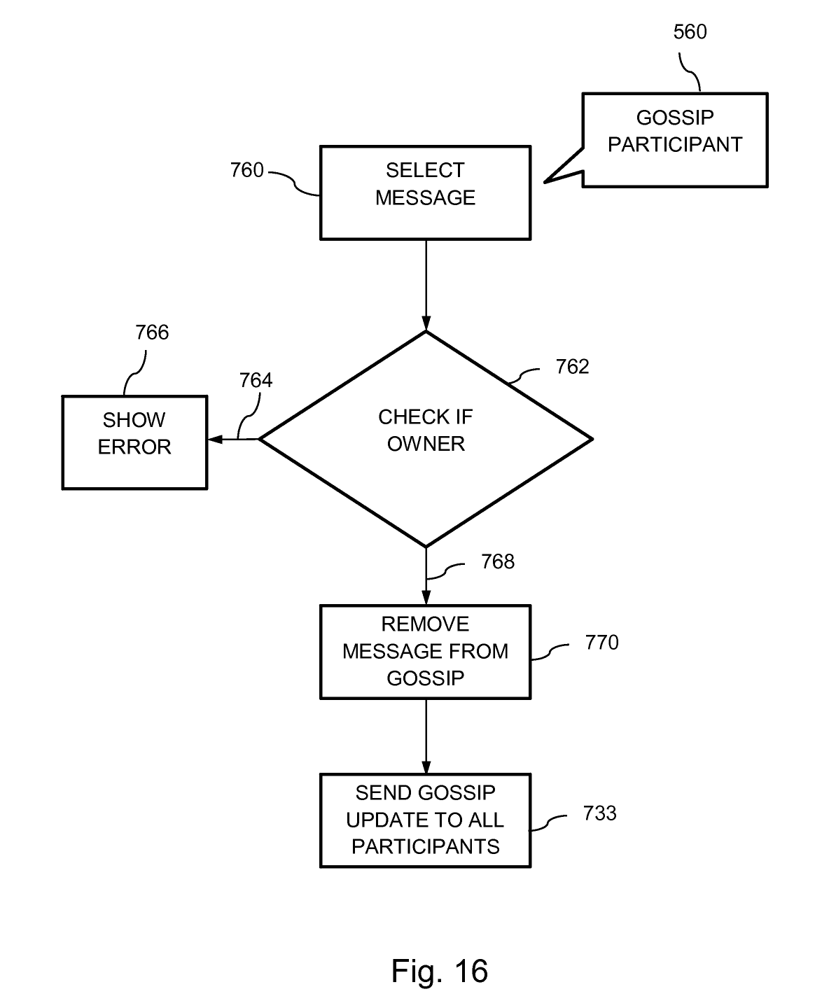

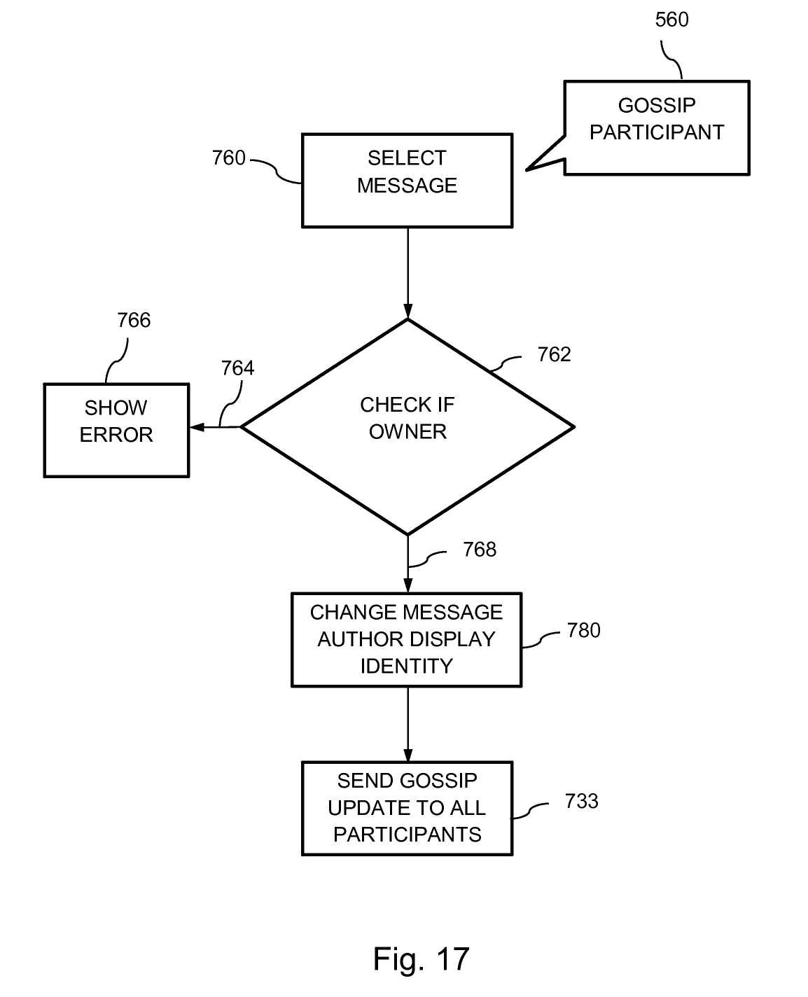

FIG. 11 shows actions possible on a Gossip 500 during its lifetime 600 in the preferred embodiment of the invention. Gossip 500 lifetime starts when it is created, see FIG. 12. Gossip 500 can be viewed by the Users 100 identified as Participants 560 of the gossip until the Gossip 500 is deleted 640 or it expires 645. In the preferred embodiment, the Gossip 500 may only be deleted by the User 100 who created it. Alternatively, Gossip 500 may be deleted automatically when its preset lifetime has expired 645. During Gossip 500 lifetime 600 any Participant 560 of the Gossip 500 may: add a message 610 (see FIG. 13), remove a message 625 (see FIG. 16), alter display identity 617 for message (see FIG. 17), add a participant 615 (see FIG. 14.), exclude a participant 620 (see FIG. 15), flag a message 630, “favorite” a message 635, or inform a non-participating user 650.

FIG. 12 shows steps involved in creating a Gossip. The process 605 of creating a Gossip 500 by a Participant 560 involves the following (not necessarily in this order). (a) Selecting other participants 705. Note that the creator of the Gossip automatically becomes one of the participants. Typically, the participants will be one or more Users 100 known to the Identity Service 410, however, it is possible to also select other Users 100 as Participants 560, and they will automatically be registered with the Identity Service. It is also possible to select Participants 560 for a gossip by identifying one or more user groups as defined by Group Data 416. (b) Composing a message 710. In the preferred embodiment the Gossip App 220 provides multiple ways to compose a Message 560. Message Content 554 can be typed as text, or entered by recording audio, or created by taking a photo, etc. (c) Choosing display identity 712. Creator of a Message 560 may choose to hide its real identity. In the preferred embodiment this can be done by not choosing any value for Author Display Identity 553 or by setting an arbitrary name or alias as Author Display Identity 553 or by choosing a name of another User 100 either known to Identity Service 410 or from the contact list of the Mobile Device 200 as Author Display Identity 553. (d) Selecting excluded participants 715. Creator of a Gossip 500 may exclude some Users 100 from being able to view the Gossip. Excluded participants are selected similarly as normal Participants 560. If they are not known to the Identity Service 410 they will automatically be registered with the Identity Service. A special type of excluded participant “everyone else” may also be selected.

Once a Gossip 500 is created the Gossip App 220 ensures that it is distributed to all gossip Participants 560. Only the Participants 560 listed in the Gossip 500 may read the contained Messages 550. Other Users 100 cannot read the Gossip unless they are made Participants 560. Non-participating Users 100 may also receive communication from the Gossip App 220, for example to inform them about a Gossip without revealing the content. In the preferred embodiment these non-participating users are selected by the Gossip App 220 from the contact list of the Mobile Device 200 or entered explicitly by a Participant 560 of the Gossip 500. Other embodiments may implement other methods of selecting which non-participating Users 100 should be informed about a Gossip 500.

New Messages 550 can be added 610 to an existing Gossip 500. This is shown in FIG. 13. Only Participants 560 of a Gossip 500 may add new Messages 550. Adding new Messages consists of the already described steps of Composing a Message 710 and Choosing Display Identity 712. In the preferred embodiment, after those steps are complete, the new message is sent 730 to all gossip participants, the message will not be sent to anyone else by the Gossip App 220.

FIG. 14 shows steps involved in adding a new Participant 560 to an existing Gossip, see also 615 in FIG. 11. A new participant can only be added by an existing Gossip 500 Participant 560. The first step is selecting 706 a new participant to add. This is similar as adding a participant to a new Gossip, see FIG. 12. Once the new participant has been identified, the Gossip App 220 will perform a check 720 of the new participant identity against the list Excluded Participants 570. If 722 the new participant is found in the excluded list or if the excluded list contains “everyone else” then an error will be shown 724 and the new participant will not be added to Participants 560 of a Gossip 500. Otherwise, 726 the new participant will be added 728 to Participants 560 of a Gossip 500 and the relationship 555 will identify all existing Messages 550 as having been created before the new Participant 560 was added. The Gossip 500, or some part of it, will then be sent 731 to the new Participant 560. In the preferred embodiment, the new Participant 560 will be shown all existing Messages 550 in the Gossip 500 while the Author Display Identity 553 of individual Messages 550 in the Gossip 500 are either kept hidden or obfuscated. In another embodiment, the new Participant 560 will be shown only a summary of all the existing Messages 550 (created prior to Participant 560 being added to the Gossip 500) in the Gossip 500.

In the preferred embodiment, it is not possible to exclude (620) an existing gossip participant. This is illustrated in FIG. 15. After a Participant 560 selects a User 100 to exclude, a check 742 is performed if the selected User 100 is a participant in the gossip. If yes 744, then an error will be shown 746. If no 748, then the selected User 100 will be added to the Excluded Participant list 570 of the Gossip 500, and gossip update is sent 733 to all participants. In certain embodiments of the invention, the Excluded Participant may be informed of the fact of Exclusion via either the Gossip App 220 or via some other means, e.g., via email or SMS.

A Message 550 may be removed (625) only by a Participant 560 who created it. This is illustrated in FIG. 16. After a Participant 560 selects 760 a message to be removed, a check 762 is performed whether Participant 560 is the owner of the selected message. If not 764, and error message is shown 766. If Participant 560 is the owner 768, then message is removed 770 from the gossip and a gossip update is sent 733 to all participants.

A Participant may at any time alter display identity (617) for the messages she created within the Gossip. This is illustrated in FIG. 17. After a Participant 560 selects a message 760 for which the author identity is to be changed, a check 762 is performed whether Participant 560 is the owner of the selected message. If not 764, and error message is shown 766. If Participant 560 is the owner 768, then the identity of the author of the selected message can be changed 780 and gossip update is sent 733 to all participants.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention.

What is claimed is:

1. In a computer-based system for instant messaging between a plurality of users, wherein each user is assigned an identity within the instant messaging system, and wherein the messages are authored by the users, said computer-based system comprising an input component and an output component,
a computer implemented method comprising the steps of:
a first step of using the input component for accepting from the author of the message a user identity different from the identity of the said author,
a second step of applying said different identity as the author identity to the message,
a third step of using the output component for outputting said different identity as the identity of the author of the message.

2. The computer implemented method of claim 1, wherein in the third step an indication is outputted if the message author identity is not the true author identity.

3. The computer implemented method of claim 1, wherein
in the first step a null user identity is accepted, and
in the third step the message is outputted without the author identity.

4. The computer implemented method of claim 1, wherein the messages in the said computer-based systems are further organized into conversations, each said conversation comprising one or more messages, and each said conversation assigned to two or more participants, said participants chosen from the users, and wherein the messages are authored by the participants, wherein in the third step of the said method true participant identities are outputted irrespective of the message author identities.

5. The computer implemented method of claim 1, further comprising the steps of:
a step of receiving one or more requests from users to show the true author identity for a message,
a decision step of applying one or more decision factors to the received requests and deciding if the requests be granted,
a step of revealing the true author identity if the request is granted.

6. The computer implemented method of claim 2, further comprising the steps of:
a step of receiving one or more requests from users to show the true author identity for a message having an indication that the message author identity is not the true author identity,
a decision step of applying one or more decision factors to the received requests and deciding if the requests be granted,
a step of revealing the true author identity if the request is granted.

7. The computer implemented method of claim 5, wherein the decision factors considered in the decision step of the said method comprise one or more of:
a number of requests received,
a number of tokens received with the requests,
a threshold set by the message author.

8. In a computer-based system for instant messaging between a plurality of users, wherein the messages are organized into conversations, each said conversation comprising one or more messages, and each said conversation assigned to two or more participants, said participants chosen from the users,
a computer implemented method comprising the steps of:
specifying one or more of the users as being on an exclusion list for a given conversation,
ensuring that the users on the exclusion list cannot be assigned as participants of the said conversation,
allowing only the conversation participants to view the messages in the conversation.

9. The computer implemented method of claim 8, wherein one or more users on the said exclusion list are informed about being on the exclusion list.

10. The computer implemented method of claim 8, wherein one or more users can be removed from the exclusion list.

11. A computer-based system for instant messaging between a plurality of users, wherein each user is assigned an identity within the instant messaging system, and wherein the messages are authored by the users, said computer-based system comprising:
a processor,
a memory,
a first component configured for:
accepting from the author of the message a user identity different from the identity of the said author,
applying said different identity as the author identity to the message,
an output component configured for outputting said different identity as the identity of the author of the message.

12. The computer-based system of claim 11, wherein the output component is further configured to output an indication if the message author identity is not the true author identity.

13. The computer-based system of claim 11, wherein
the first component is further configured for accepting a null user identity from the author of the message,
the output component is further configured for outputting the message without the author identity if null identity was accepted in the first component.

14. The computer-based system of claim 11, wherein the messages are further organized into conversations, each said conversation comprising one or more messages, and each said conversation assigned to two or more participants, said participants chosen from the users, and wherein the messages are authored by the participants, wherein
the output component is further configured for outputting true participant identities irrespective of the message author identities.

15. The computer-based system of claim 11, further comprising a third component configured for:
receiving requests from users to show the true author identity for a message,
applying one or more decision factors to the received requests and deciding if the requests be granted,
revealing the true author identity if the request is granted.

16. The computer-based system of claim 12, further comprising a third component configured for:
receiving requests from users to show the true author identity for a message having an indication that the message author identity is not the true author identity,
applying one or more decision factors to the received requests and deciding if the requests be granted,
revealing the true author identity if the request is granted.

17. The computer-based system of claim 15, wherein the decision factors considered by the third component comprise one or more of:
a number of requests received,
a number of tokens received with the requests,
a threshold set by the message author.

18. A computer-based systems for instant messaging between a plurality of users, wherein the messages are organized into conversations, each said conversation comprising one or more messages, and each said conversation assigned to two or more participants, said participants chosen from the users, said computer-based system comprising:
a processor,
a memory,
a first component configured for:
specifying one or more of the users as being on an exclusion list for a given conversation,
ensuring that the users on the exclusion list cannot be assigned as participants of the said conversation,
a second component configured for allowing only the conversation participants to view the messages in the conversation.

19. The computer-based system of claim 18, further comprising a third component configured for informing one or more users on the said exclusion list about being on the exclusion list.

20. The computer-based system of claim 18, further comprising a fourth component configured for removing one or more users from the exclusion list.
